(19) United States
(12) Patent Application Publication
(10) Pub. No.: US 2009/0271293 A1
(43) Pub. Date: Oct. 29, 2009

(54) METHODS AND SYSTEMS FOR DYNAMICALLY GENERATING PERSONALIZED SHOPPING SUGGESTIONS

(75) Inventors: Alexander Parkhurst, Denver, CO (US); Robert C. Orr, Littleton, CO (US); Joseph Callaghan, Lakewood, CO (US); Ismail S. Abbass, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Interactive Luxury Solutions LLC, Denver, CO (US)

(21) Appl. No.: 12/111,144

(22) Filed: Apr. 28, 2008

(51) Int. Cl. G06Q 30/00

(52) U.S. Cl. 705/27

(57) ABSTRACT

Methods and systems of establishing a shopping assistant utility are described. The method may include receiving product information for products, and based on the received product information, automatically generating a product profile for each of the products. Each product profile includes attributes assigned to the product. The method may further include receiving a search request including search criteria corresponding to at least one of the attributes, and comparing the search criteria with the attribute of the products to determine a level of correlation between each of the products and the search criteria. Further, the method may generate a score assigned to each of the products based on the determined level of correlation and present the products in an ordered list based on the generated scores assigned to each of the products.

### CROSS-REFERENCES TO RELATED APPLICATIONS

This application is related to U.S. patent application Ser. No. 11/828,207, entitled PERSONALIZED SHOPPING ASSISTANT, filed on Jul. 25, 2007, which is incorporated by reference for any and all purposes.

### FIELD OF THE INVENTION

This application relates generally to electronic commerce. More specifically, this application relates to methods and systems of dynamically generating personalized shopping suggestions.

### BACKGROUND OF THE INVENTION

In the years since the introduction of the Internet, one of its most useful functions has been to provide a convenient mechanism for making purchases. Indeed, the use of electronic commerce has steadily increased and continues to increase in popularity. The main reasons for such popularity are the convenience that the Internet offers to consumers to review offerings of various products from the convenience of their homes or offices and the ability to arrange for direct delivery of goods. A significant time benefit is provided to consumers in being able to conduct transactions without needing to visit stores physically. And the various search engines provided on the Internet generally makes it easier for consumers to identify the specific products they wish to purchase, frequently avoiding the need to make physical visits to merchants to review and evaluate products being considered.

But even with these benefits, there remain certain fundamental aspects to the shopping experience that can cause frustration for consumers. One of these is the difficulty in identifying suitable gifts for recipients. Consumers frequently wish to purchase a gift for a particular recipient and wish to purchase one that the recipient is likely to appreciate and enjoy, but are uncertain about how to go about identifying such a gift. Various tools that exist as an aid to electronic commerce do not directly address this difficulty.

For example, a common practice currently allows consumers to generate “wish lists” of specific gifts they would like to receive. This allows purchasers to review the lists generated by a particular recipient and to select one of the items. But many purchasers dislike the impersonal nature of simply buying an object that the recipient has requested, preferring to identify something independently that the recipient will enjoy. Other tools monitor purchases made by individuals and use correlation algorithms to identify the age and preferences of the individuals. This may provide some guidance to a consumer of the general category of goods and services that the recipient might enjoy, but lacks specificity.

There is accordingly a need in the art for improved methods and systems of aiding product selections in electronic commerce.

### BRIEF SUMMARY OF THE INVENTION

Embodiments of the present invention provide for a method of establishing a shopping assistant utility. The method may include receiving product information about products, and based on the received product information, automatically generating a product profile for each of the products. Each product profile includes attributes assigned to the product. The method may further include receiving a search request including search criteria corresponding to at least one of the attributes, and comparing the search criteria with the attribute of the products to determine a level of correlation between each of the products and the search criteria. Further, the method may generate a score assigned to each of the products based on the determined level of correlation, and present the products in an ordered list based on the generated scores assigned to each of the products.

Further embodiments of the invention thus provide methods of providing purchasing suggestions to a shopper. Data are maintained representing one or more profiles of individuals. Each such profile includes a plurality of fields descriptive of qualities of one of the individuals. A request is received over a public network from the shopper to provide a purchasing suggestion for a recipient. A level of correlation is evaluated between aspects of each of a plurality of products with the qualities of the recipient according to the profile of the recipient. A list of products having the level of correlation exceed a defined threshold value is generated. The list is provided to the shopper.

In different embodiments, the qualities of the individuals comprise demographic information, interests and/or tastes of the individuals, and/or indications of price ranges for shopping recommendations. The profile of the recipient may sometimes comprise an identification of one or more excluded aspects, with the list being generated by excluding products having any of the excluded aspects. In other instances, at least some of the qualities comprised by the recipient's profile are associated with a weighting factor so that evaluating the level of correlation comprises weighting those qualities with the weighting factor.

Certain embodiments of the invention also make use of rating. For example, at least some of the products comprised by the generated list may be associated with ratings derived from feedback information provided by other shoppers; in such instances, the ratings may be provided to the shopper with the list. An evaluation may accordingly be received from the shopper for a selected one of the products that indicates a level of acceptability of the selected one of the products to the recipient, permitting the rating for the selected one of the products to be modified in accordance with the evaluation. In some cases, a plurality of merchant sites may be searched using the public network to identify at least some of the products.

In some instances, a selection of a product on the list is received from the shopper so that a purchase request for the product may be initiated on behalf of the shopper using stored financial-account information. There are also embodiments in which the request from the shopper includes an override of a quality of the recipient. In such embodiments, evaluating the level of correlation between aspects of each of the plurality of products with the qualities of the recipient is modified by the override.

The recipient may sometimes also be the shopper. There are also embodiments in which the shopper is one of a plurality of shoppers having access to the profile of the recipient over the public network. The profile of the recipient may be generated at least in part by the recipient, by the shopper, or by someone who is neither the shopper nor the recipient.

Methods of the invention may also be embodied by a computer-readable storage medium having a computer-readable program embodied therein for directing operation of a personal-shopping-assistant computer, which may include a communications system, a processor, and a storage device. The computer-readable program includes instructions for operating the personal-shopping-assistant computer to implement the methods as described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 provides a schematic overview of an architecture for electronic commerce within which the invention may be embodied;

FIG. 2 provides a schematic illustration of a computational structure that may be used to implement the personal-shopping-assistant computer;

FIG. 3 is a flow diagram that summarizes methods in accordance with embodiments of the invention to establish product profiles used to dynamically generate customized product shopping lists;

FIG. 4 is a flow diagram that summarizes methods in accordance with embodiments of the invention to search products using the established profiles;

FIG. 5 is a block diagram that summarizes systems in accordance with embodiments of the invention to dynamically generate customized product shopping lists;

FIG. 6 is a flow diagram that summarizes methods in accordance with embodiments of the invention to establish profiles used by the personal-shopping-assistant computer;

FIG. 7 provides an example of screen that may be used to enter or review profile information; and

FIG. 8 is a flow diagram that summarizes methods in accordance with embodiments of the invention for using the personal-shopping-assistant computer.

### DETAILED DESCRIPTION OF THE INVENTION

Aspects of the present invention relate to providing a vendor (or manufacturer) with a mechanism for presenting their customers with personalized shopping assistance. In one embodiment, the vendor may be able to categorize and classify their products based on attributes classifications. For example, a certain product (e.g., shoes) may be classified by the shoes' color (e.g., black, brown, white, etc.), fabric (e.g., leather, cloth, canvas, etc.), and style (e.g., classic, hip, conservative, etc.). Each of the attribute classifications may be further classified into sub-classifications. For example, leather may be classified as suede, rawhide, fine-grained, etc. Furthermore, attribute classifications and sub-classifications may be customized to fit a vendor's specific product, or alternatively may be generally used for a variety of vendors and/or products.

Further aspects of the present invention relate to utilizing the attribute classifications to present customers with personalized shopping assistance. In one embodiment, a customer may input various search criteria. The search criteria may then be compared against the attribute classifications in order to produce correlative matches between the products and the search criteria. Based on the level of correlation of the products with the customer's search criteria entered, a number of products may be displayed to the customer. Furthermore, individual items may be associated with complementary items. For example, each individual item, based on the item's attributes may be “searched” in order to determine which complementary items have the highest level of correlation with the item. Hence, a list of the most likely complementary items may be generated for each individual item. One example of complementary items may be a pair of earrings or pair of shoes which may compliment a certain purse. Hence, items in which a customer may not have thought of or may be an impulse buy can be presented to the customer.

Further embodiments of the invention make use of profile information for gift recipients to make recommendations for purchases, perhaps in accordance with certain filtering criteria imposed by the purchaser. In some embodiments, execution of the purchase transaction may also be automated, generally simplifying the process by which consumers may affect a variety of gift purchases.

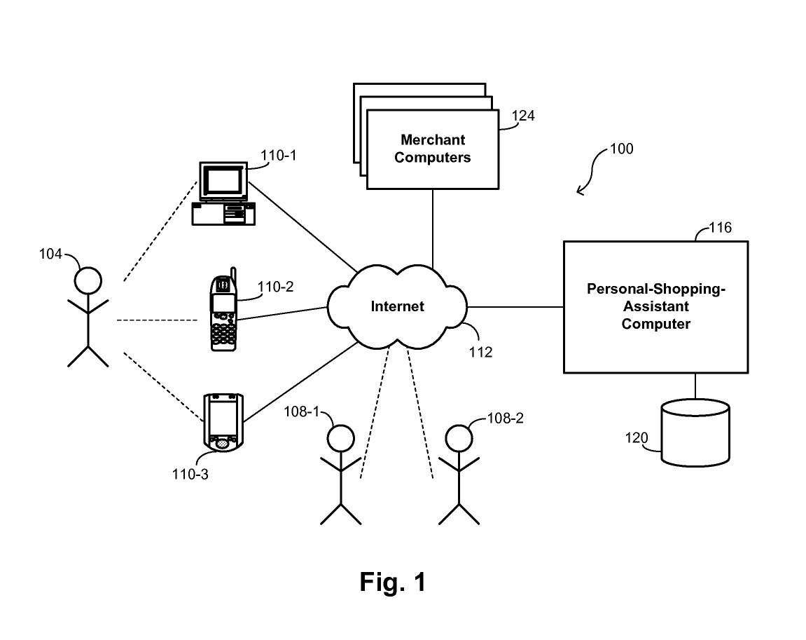

A general architecture within which embodiments of the invention may be implemented is shown schematically in FIG. 1. This architecture 100 makes use of a public network such as the Internet 112 to effect communications between at least a consumer 104 and a personal-shopping-assistant computer 116. The consumer 104 may interface with the Internet 112 using any Internet-enabled device 110. The drawing shows a personal computer 110-1, cellular telephone 110-2, and a personal digital assistant 110-3 as examples of Internet-enabled devices that may be used in different embodiments, but this is not intended to be restrictive; more generally, any Internet-enabled device may be used. Communications may also be effected with the Internet 112 by other parties 108 using similar kinds of devices that are not explicitly shown in the drawing. In some instances, such other parties 108 may comprise potential gift recipients.

There are a number of different reasons why such recipients might use access to the Internet 112, although such access is not required in all implementations of the invention. For example, a gift that is purchased might be such that it requires an Internet connection to make use of the service; this might be the case where the gift comprises a subscription to a video-on-demand service, comprises an electronic gift certificate to an online merchant, comprises access to an Internet-based game, or some other such gift. In cases where a gift is a physical item that may be delivered to the recipient, it is possible for recipients to participate without having any Internet connection. There are also embodiments described below in which a recipient may interact directly with the personal-shopping-assistant computer 116, such as by providing information that is included in his or her profile.

There are at least two distinct techniques that may be used by the personal-shopping-assistant computer 116 in identifying potential gift suggestions. First, a data store 120 provided in communication with the personal-shopping-assistant computer 116 may store information about products and how they are classified according to criteria used in making suggestions. This data store may also be used to store the profiles, or different data sources may be used for storage of profile information and for storage of product information. Second, the personal-shopping-assistant computer 116 may use connections with merchant computers 124 through the Internet 112 to initiate searches of products offered on such web sites. This may involve the use of a web robot having sufficient software to apply filtering criteria used in identifying products that satisfy the criteria specified in the recipient's profile.

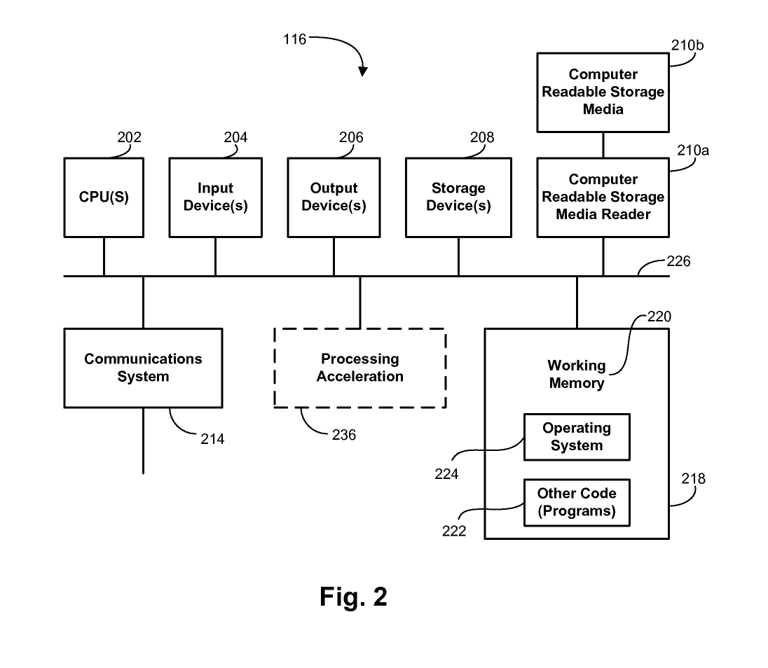

FIG. 2 provides a schematic illustration of a structure of the personal-shopping-assistant computer 116 (FIG. 1) that may be used to implement embodiments of the invention. FIG. 2 broadly illustrates how individual system elements may be implemented in a separated or more integrated manner. The computer 116 is shown comprised of hardware elements that are electrically coupled via bus 226, including a processor 202, an input device 204, an output device 206, a storage device 208, a computer-readable storage media reader 210a, a communications system 214, a processing acceleration unit 236 such as a DSP or special-purpose processor, and a memory 218. The storage device 208 may, in some instances, correspond to the data store 120, but may alternatively comprise a device separate from the data store 120 (FIG. 1). The computer-readable storage media reader 210a is further connected to a computer-readable storage medium 210b, the combination comprehensively representing remote, local, fixed, and/or removable storage devices plus storage media for temporarily and/or more permanently containing computer-readable information. The communications system 214 may comprise a wired, wireless, modem, and/or other type of interfacing connection and permits data to be exchanged with the Internet 112 (FIG. 1) to implement embodiments as described herein.

The computer 116 (FIG. 1) also comprises software elements, shown as being currently located within working memory 220, including an operating system 224 and other code 222, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

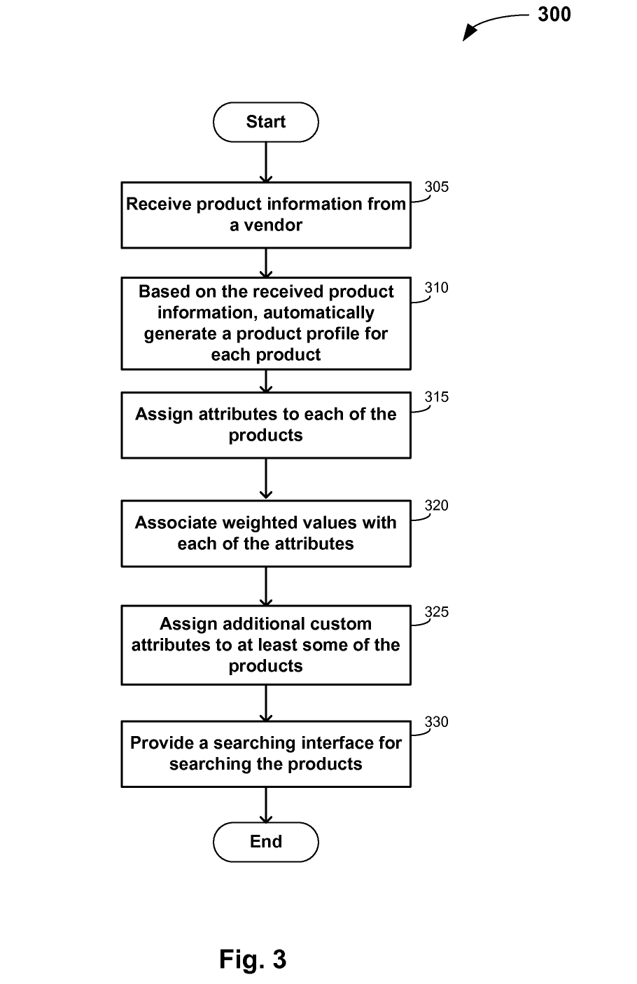

Turning now to FIG. 3 which illustrates a method 300 of dynamically generating customized purchasing suggestions to be presented to a potential customer. At process block 305, product information may be received from a vendor (i.e., merchant, wholesaler, etc.). The product information may be received in a variety of formats. For example, the product information may be in a .net, java, php, cold fusion, etc., implementation format. Furthermore, the product information may include a variety of attributes. For example, each product may have its own data record and within the record there may be included a number of fields representing attributes. Attributes may include color, material type, style type, cost, brand, etc. Hence, the received product information includes detailed information regarding each of the vendor's products.

At process block 310, based on the received product information, product profiles for each of the products may be automatically generated. For example, if the product information includes color, style, and brand, then the product profiles would be created to include a color attribute, a style attribute, and a brand attribute assigned to each product (process block 315). The product profiles would then be populated with the attribute information received from the product information. In one embodiment, the product profiles could include attritional attribute fields and/or identification fields (e.g., product name, etc.). The generation process is automated due, in part, to the fact that the profile generation is driven by the product information as it is received. In other words, if product information with different attributes were received, the product profiles would reflect the change in the attributes.

In a further embodiment, weight values may be associated with each of the attributes (process block 320). For example, the vendor may decide that of the three exemplary attributes color is most important when searching their products. Accordingly, color may have an extra weighting associated with it. The weighting scale may be from 1 to 5, with 5 granting the highest weight. However, other weighting systems and values may be used. The color attribute may be assigned a weight of 5, style (less important) may be assigned a 3, and brand (even less important) may be assigned a 2. Therefore, a vendor can direct customers' searching by using these assigned weights. In addition, these weightings would be customizable and may be altered by the vendor.

In an alternative embodiment, product profiles may be created with default attributes assigned to each product. In such a situation, the vendor may desire to add additional custom attributes to some or all of the products (process block 325). If, for example, the vendor sells shoes and diamonds, a custom attribute for diamonds may be a clarity rating, whereas shoes would not need such an attribute. In contrast, the vendor may sell lawnmowers and would require the custom attribute horsepower, which would apply to all of the vendor's products. Accordingly, the vendor has the flexibility to fully describe their products in order to enhance searching of their products.

At process block 330, a searching interface may be provided. The searching interface may be, for example, a web-based interface. In the web-based searching interface, a customer may be presented with a number of text fields, pull-down menus, radio buttons, etc., used to receive the customer's input for their search criteria. In an alternative embodiment, the searching interface may be a “plug-in” tool used by the vendor's website. Once the customer has completed inputting their search criteria, they can then click a submit button, or the like, in order to submit their search. Additionally, the customer may be able to access the searching interface using a handheld device, a cellular device, a portable computer, etc. Alternatively, the customer may be able to enter their search criteria using an interactive voice recognition (IVR) system, or the like.

In one embodiment, the search criteria may include values for the product attributes. For example, the search criteria may include brown for color, conservative for style, and Prada™ for brand. The customer may also be given the option of weighting certain criteria according to their own preference. Once the customer has completed inputting their search criteria, the search information may be transmitted to a searching tool and/or search engine to process the search request.

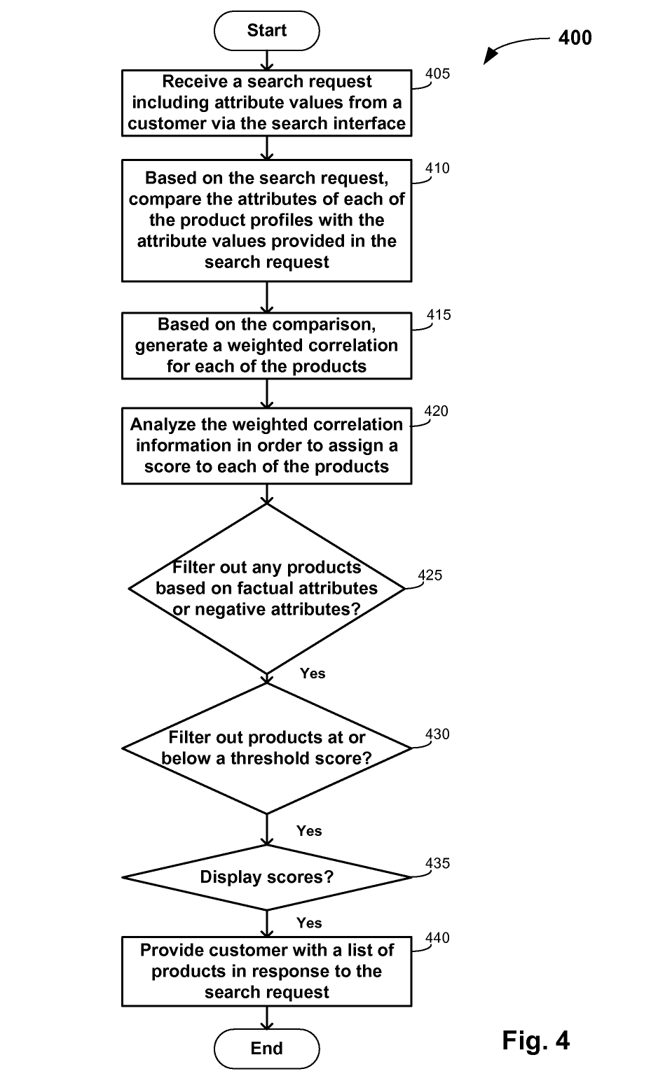

Referring now to FIG. 4 which illustrates a method 400 of searching products using the established profiles and input search criteria from FIG. 3. At process block 405, a search request including the search criteria, which includes the attribute designations may be received by the searching tool and/or search engine. The search request may be received in a variety of formats and then be translated into, for example, an XML format. Accordingly, with the search request in an XML format, it can be universally read by any computing system utilizing any system implementation. Therefore, the vendor's system implementation and the searching tool's system implementation do not need to be the same or even compatible. Information can be transmitted between the two systems using, for example, XML.

Alternatively, a user interface may be presented to a user/customer in order to receive the search criteria. In one embodiment, the user interface may be implemented using an iFrame. An iFrame is an HTML element which makes possible the embedding of another HTML document within a main HTML document. The embedded document can, with relative ease, be “dropped” into the main HTML document with little of no significant changes made to the main HTML document, thus become part of the main HTML document. Hence, the search engine can be developed once, and inserted into various vendors' systems without the need for redesigning or recoding the interface for each vendor.

Furthermore, the need for translation of product information from the vendor's format into XML and then from XML into the search engine's format can be eliminated. Instead, since the iFrame HTML document is configured to be able to interface with the search engine, and is essentially part of the vendor's HTML document, the need for translation can be eliminated. As such, the needed product information can simply be accessed by the iFrame HTML document and passed to the search engine.

At process block 410, a comparison between the attribute values from the search request and the attribute values of each of the vendor's products may be performed. By performing this comparison, data can be gathered about how close each product is to the customer's search criteria. At process block 415, based on the gathered comparison data, a weighted correlation for each of the products may be generated. For example, correlation functions relating the similarity of the product to attributes specified in the search request may be used to derive ratings that indicate the likely acceptability of the item to the customer. Certain artificial-intelligence techniques may be used in different embodiments of the invention to implement such correlation functions. Such artificial-intelligence techniques that may be used include the use of expert systems, the use of genetic algorithms, etc., all of which are familiar to those of skill in the art.

In a further embodiment, the vendor and/or customer weighting of attributes may be considered when determining a product's level of correlation with the search criteria. For example, referring back to the example above, if a product's color matches the search criteria's color, the color attribute for that particular product would generate a higher score then if the product's style matched the search criteria's style due to the higher weighting assigned to color. For example, an exact match for color may produce a value of 110, whereas an exact match for style may only produce a value of 100, and an exact match for brand may produce a value of 90, and so forth. Accordingly, the weighting of the attributes would affect the overall score assigned to each product.

At process block 420, an analysis of the weighted correlation information is performed in order to generate scores to assign to each product. The scores may be, for example, a sliding scale between 0 and 100. Alternately, there may be a total point scale which sums the total points for all of the attributes and produces a corresponding score for each product. The score may also be a weighted average of the scores received by each attribute for the product normalized to 100. Nonetheless, each product is assigned a score based on how closely the product correlates with the received search criteria.

At decision block 425, it may be determined whether there are any factual or negative attributes to filter out from the list of products. A factual attribute may be a yes/no or true/false attribute. For example, a product such as clothing may have an attribute which is either male clothing or female clothing. As such, the search criteria may have a female designation within the criteria. Accordingly, any product which has its gender designation set to male would be filtered out of the list of products. Similarly, if a product has its gender attribute set to female, or does not have a gender attribute (i.e., unisex products), then those products would not be filtered out.

At decision block 430, a determination may be made whether to filter out products with a score below a certain threshold value. For example, the threshold may be set to a score of 70, in which only products with a score at 70 or above will remain in the products list. Alternatively, the threshold may be tied to the total number of products returned in response to the search. For example, the threshold may be set to 100, which would mean that only the top 100 products are to remain in the list regardless of their score. Furthermore, a combination of a score threshold and a total number of products threshold may also be employed.

In a further embodiment, at decision block 435, a determination may be made as to whether or not to display the scores assigned to the products to the customer. By displaying the scores the customer may be influenced by the numeric value associated with the products. In some situations this may be beneficial in attempting to sell a product to the customer. However if, for example, the scores are all fairly low, this may discourage the customer from purchasing the products. Accordingly, the determination whether to display the score may be based on an average of the scores, the scores of the top 10 products, etc., in order to avoid negatively affecting whether a customer purchases a product.

At process block 440, the customer may be provided with a list of products in response to their search request. In one embodiment, the list of products may be displayed on a webpage, with hyperlinks to each of the products. Alternatively, the list may be emailed to the customer to be viewed later, or the customer may receive the list in a text message. The customer may be able to save the search in their profile for later retrieval. Nonetheless, the customer is presented with a customized list of product purchasing suggestions based on the customer's search criteria.

In a further embodiment, each product itself may be associated with complementary products. For example, based on the products found in response to the search request, each product may also be searched to determine other products that are most complementary to the product. In one embodiment, this process of determining complementary products may be a recursive process. Each product may then have the products with the highest level of correlation displayed as complementary products. One example may be a pair of shoes for which complementary products may be a purse, a pair of earrings, and a belt, each of which have a certain correlative score above a threshold with respect to the pair of shoes. As such, a customer may now be presented with “impulse buys” of items they may not have thought of or that are not in their direct search criteria.

In another embodiment, where multiple vendors' products are being searched, a preferred vendor value may be factored into the score determination for each of the products. For example, if product A from vendor Y and product B from vendor Z have the same score, and vendor Y is a preferred vendor, then the preferred vendor value would move product A in front of product B in the product list. Alternatively, all of the products from a preferred vendor may be displayed first in the list regardless of other vendors' products having a higher score.

In yet another embodiment, based on having multiple vendors, a “virtual mall” may be created. A virtual mall may be, for example, a collection of vendors products gathered together and displayed at a single website. The virtual mall would appear to a customer that all of the products are from the same website, and the customer could search the products of all of the vendors collectively. Alternatively, the virtual mall may be a collection of hyperlinks to websites for the multiple vendors in which a customer could click on and be transferred to the vendors' site.

In a further embodiment, certain products may be flagged as “surplus” or “discounted” products. If a product is a surplus or discounted product it may be assigned a higher score, or it may be placed at the top of the search list regardless of its score. Accordingly, these products will be more likely to be purchased by a customer because they are displayed at the top of the list or given a higher score.

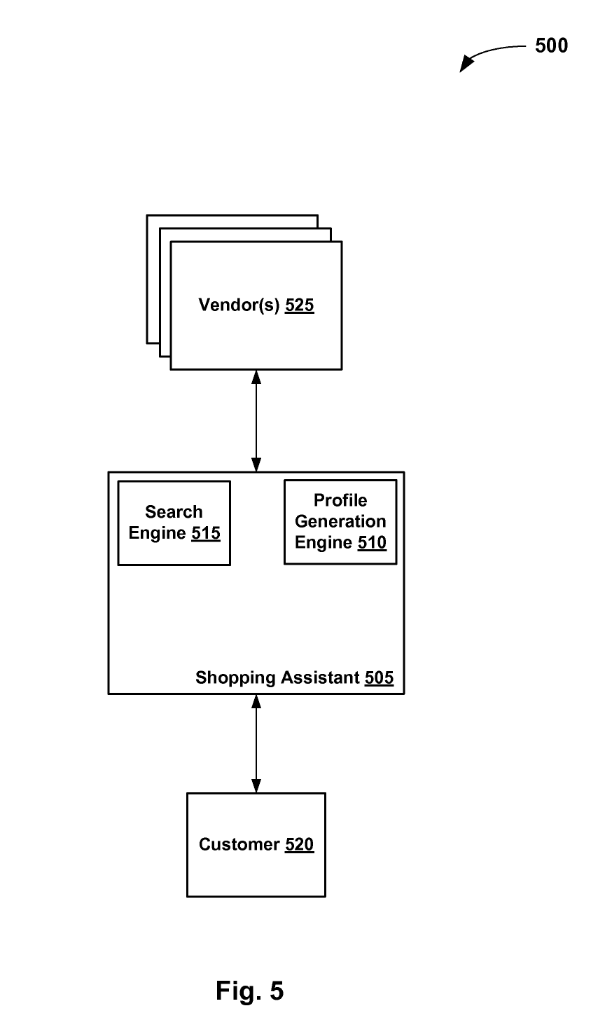

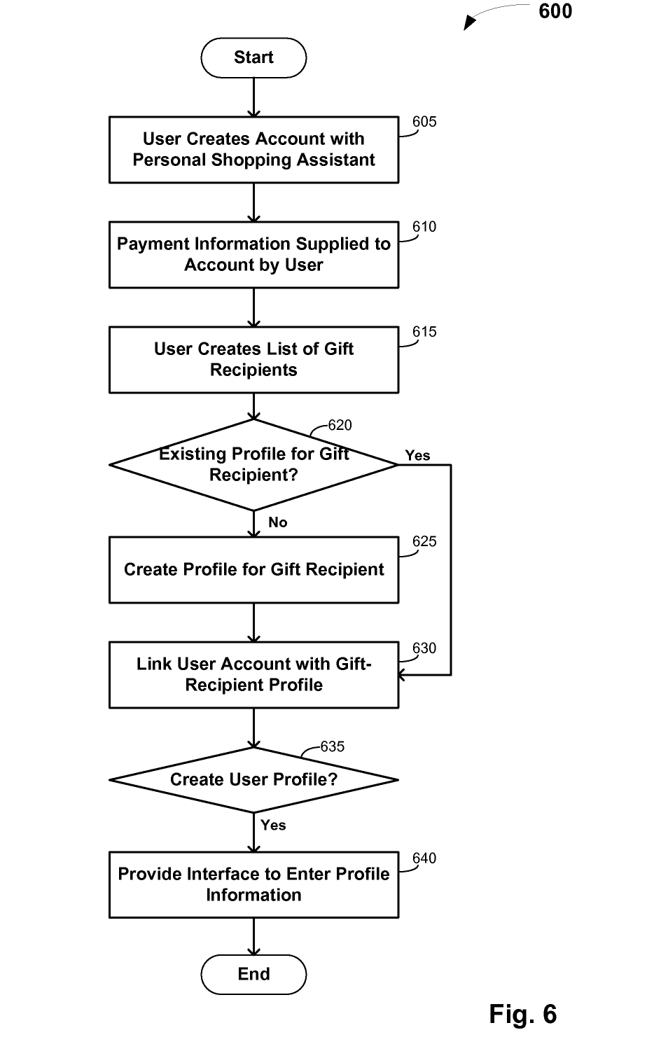

Turning now to FIG. 5 which illustrates a system 500 for dynamically generating customized product shopping lists. In one embodiment system 500 may include a shopping assistant 505. Shopping assistant 505 may be deployed as a webpage, or alternatively may be a plug-in deployed at vendor(s) 525's website. In one embodiment, shopping assistant 505 may include a profile generation engine 510 and a search engine 515. Profile generation engine 510's profile generation process is shown in detail in FIG. 6 below.

In one embodiment, search engine 515 may implement methods 300 and 400 from FIGS. 3 and 4 above. As such, search engine 515 may generate product profiles based on product information received from vendor(s) 525, and receive search requests from customer 520. Search engine 515, based on the search request, may then generate a list of products which correlates most to the search request's search criteria. A list of products may then be displayed to customer 520. In one embodiment, shopping assistant 505, customer 520, and vendor(s) 525 are each implemented on computer systems (i.e., computer system 116 as described in FIG. 1 and FIG. 2).

In a further embodiment, shopping assistant 505 may generate messages to be sent to customer 520. For example, such a message may include a reminder message regarding an anniversary, birthday, holiday, etc. which is approaching. Customer 520 may be prompted to search products for the occasion. The search may be directed at appropriate products for the occasion. For example, vendors which sell chocolates, flowers, and jewelry may be targeted when the occasion is Valentine's Day. If the occasion is a person's birthday or an anniversary, customer 520 may be prompted to access the person's profile or to create a profile if none exists. Hence, the search may be directed to products based on the preferences of the other user's profile.

In another embodiment, shopping assistant 505 may allow customer 520 to share their profile with other customers. Accordingly, when searching for products for other customers, customer 520 would be able to better direct their searches. Additionally, shopping assistant 505 may also provide customer 520 with invitations to send to other individuals which are not yet users of shopping assistant 505.

Turning now to FIG. 6 which is a flow diagram that provides a general overview of how a profile may be created and linked with a particular potential gift recipient using the architecture described in connection with FIG. 1. The method 600 begins generally with a user of the service connecting with the personal-shopping-assistant computer 116 (FIG. 1) over the Internet 112 (FIG. 1) and creating an account at process block 605. Creation of an account may involve supplying such identification information as a name and address, email account address, telephone number, and the like. In addition, payment information may be supplied to the account by the user at process block 610. When supplied, such payment information will generally include sufficient financial-account information that the personal-shopping-assistant computer will be capable of entering into financial transactions merely upon receipt of approval from the user. For example, a credit-card number could be supplied with additional identification information such as an expiration date and a three- or four-digit verification number that is often printed on the reverse of a credit card. Alternatively, debit-card information could be supplied or information identifying an online account service such as PayPal® or StormPay.com could be supplied.

Once an account has been established, the user may create a list of potential gift recipients at process block 615. There are a number of different mechanisms by which profiles for gift recipients may be managed. For instance, in some embodiments, the profile for each gift recipient is unique to the user. That is, in such embodiments, even if multiple users identify the same gift recipient, each user will have a separate profile for that recipient so that the profiles may differ from user to user. In other embodiments, though, the profile for common gift recipients may be shared. Such sharing has the advantage that information garnered by one user may be applied by another user in generating personal-shopping recommendations. In certain implementations, the user may be given a choice for each user that is registered whether to use a common profile or to limit shopping recommendations to being derived from that user's unique profile for that recipient. Furthermore, in some instances, the profile information for a particular recipient may be generated in whole or in part by the recipient himself. This is a feature that may be included when users of the system are also potential gift recipients of other users. Such an arrangement is discussed in further detail below.

Decision block 620 of the drawing thus checks whether a profile already exists for each gift recipient identified by the user in creating the list of gift recipients at process block 615. If not, or if the user decides to generate a unique profile and not to use a common profile, a profile is created by the system at process block 625. Creation of such a profile may proceed in a number of different ways using different kinds of interfaces with the user. A convenient mechanism for generating the profile makes use of a set of fields displayed graphically to the user that can be populated with relevant profile information. An example of such a set of fields is provided in FIG. 4, certain details of which are discussed further below. Once a suitable profile exists, the user account is linked with the gift-recipient profile at process block 630.

As intimated above, in some embodiments, the user may also create a profile. This allows the user to enter information about himself that may be used in generating purchase recommendations for others who use the system. In some respects, this may advantageously allow the profile information to be more accurately reflective of the recipient. It will generally not be the case that the user is required to generate a profile, with the system more usually providing an option as indicated at decision block 635 whether the user wishes to create a profile. If so, an interface is provided at process block 640 similar to the interface provided at process block 625 for the user to enter profile information. Once the user profile is created, other users of the system may be able to link their own accounts to it when seeking the help of the personal-shopping-assistant computer 120 in generating recommendations. A mechanism may also be provided to edit the profile information, either by users who have linked their accounts to the profile or by the recipient depending on the embodiment actually being implemented.

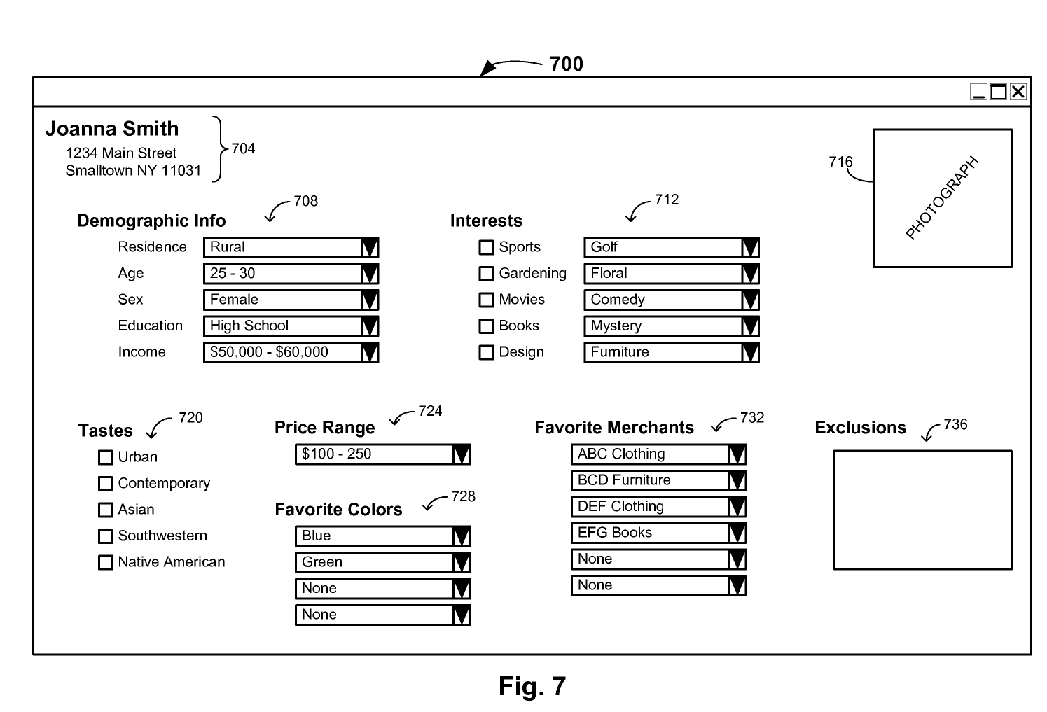

One example of an interface 700 that may be used in some embodiments is shown in FIG. 7 This is presented as a screen shot of a typical profile that includes a combination of check boxes and drop-down menus to enter a variety of kinds of information that may be used in generating recommendations. In other embodiments, the profile interface may take different forms. Information included in the profile generally comprises an identification of the recipient 704 and perhaps a photograph of the recipient 716.

The profile information that is available to be used in generating gift recommendations may include demographic information 708, an identification of the recipient's interests 712, an identification of the recipient's interests 712, an identification of the recipient's tastes 720, in identification of a suitable price range 724 for a gift, an identification of the recipient's favorite colors 728, an identification of the recipient's favorite merchants 732, and so on.

Demographic information 708 may include such things as an identification of the nature of the recipient's residence location, an age range for the recipient, the recipient's sex, the education level achieved by the recipient, the annual income of the recipient, and other such demographic factors. Examples of interests 712 that might be used in generating gift recommendations are included on the drawing, and it is generally expected that multiple such interest categories may be selected by using a combination of check boxes to identify categories of interests and drop-down menus that provide more specificity of the nature of each interest. Check boxes may similarly be used to identify tastes 720 of the recipient so that multiple tastes may be identified. The use of check boxes in this manner generally affords each interest and each taste that is identified the same weight. But in other embodiments, different weighting factors could be assigned to such qualities by using a numerical scheme, such as one in which the person uses a 1 to indicate the quality is of low weight, a 10 to indicate the quality is of high weight, and intermediate numbers indicating intermediate weights for the quality.

In addition to specifying these various qualities, certain embodiments of the invention also permit exclusions 736 to be specified. Such exclusions act to suppress certain recommendations that might otherwise be made by identifying types of merchandise, merchants, colors, brands, or other qualities that are likely not to be well received by the recipient. It is otherwise possible that a recommendation might be generated that meets various of the preferences identified in the profile but is undesirable because of some other quality. The override provided by the identified exclusions 736 avoids such a result.

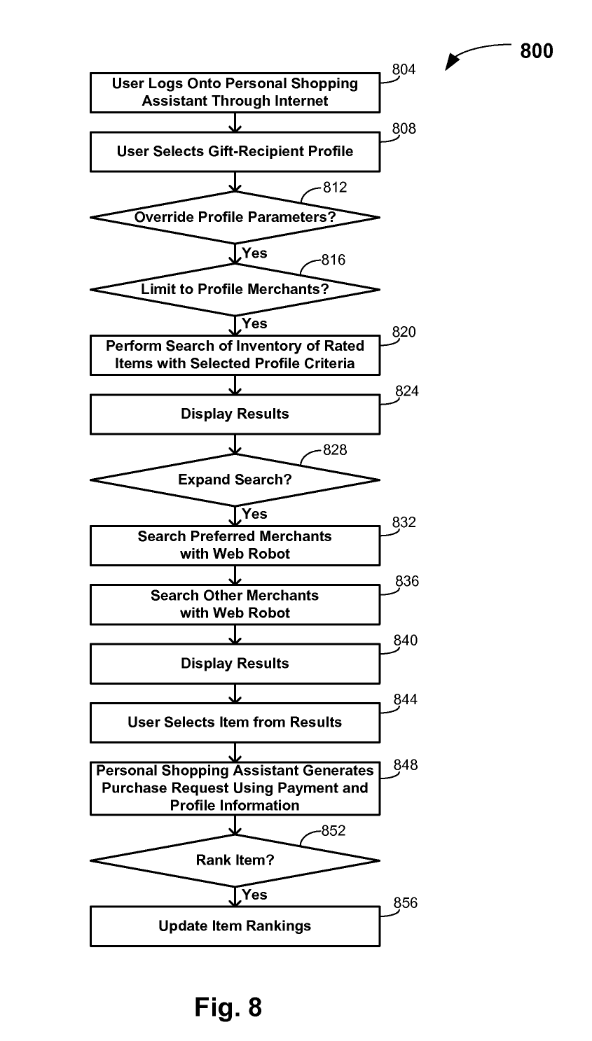

Once a profile has been established for a particular recipient, the system may be used to generate gift recommendations for that recipient. One such method 800 is summarized with the flow diagram of FIG. 8. While this flow diagram sets forth a number of specific steps and indicates a particular order for performing the steps, this is not intended to be limiting. In various alternative embodiments, some of the steps may be omitted, additional steps not indicated explicitly may be performed and/or the order of the steps may be changed. Selection of a gift may begin at process block 804 with the user logging onto the personal shopping assistant through the Internet. The user selects the profile for the particular recipient from the list of recipients linked to the user's account at process block 808.

In some embodiments, an option may be provided to override certain parameters of the profile. This is similar in operation to the exclusions discussed above, but the exclusions are a more permanent feature of the profile that prevent recommendations falling into excluded categories from ever being provided. The override option at decision block 812 allows individual overrides to be applied to an individual recommendation session without necessarily applying to other recommendation sessions. This allows the recommendations to be tailored for a particular gift to reflect particular circumstances or events. In addition, an option may be provided to limit the recommendations to the preferred merchants identified in the profile at decision block 816. In different implementations of the invention, the merchants from whom products included in the recommendations are supplied may be tailored in a manner similar to the override provisions. If the merchants are limited at decision block 816, recommendations will be provided only for products supplied by merchants identified in the recipient's profile; otherwise, the recommendations may be more expansive and include products from other merchants also.

Once the criteria for developing recommendations have been thus defined, a search is performed for suitable products at process block 820. This may initially take place by searching an inventory of items maintained by the personal-shopping-assistant computer 120 (FIG. 1). In particular, the search may be made against items that have been rated by other users for how well they were received by recipients having similar profile criteria. Such information may be helpful to the user in making a final selection. There are a variety of statistical methods known to those of skill in the art that may be used to assess the similarity of profiles and to derive appropriately weighted rankings of recommended items based on the ratings provided by other users.

The search of inventory items to identify those products that are to be recommended may also make use of a variety of different statistical techniques known to those of skill in the art. For example, correlation functions relating the similarity of the product to qualities specified in the recipient's profile may be used to derive ratings that indicate the likely acceptability of the item to the recipient. In some instances, the availability of rating information by other users permits the system to be adaptive by changing the rankings based on new information that is received. Certain artificial-intelligence techniques may be used in different embodiments of the invention to implement such adaptability. For example, a neural network may be established in which input nodes define combinations of qualities that appear in different profiles and output nodes define appropriate ratings for particular products. A set of intermediate nodes in the neural network may have its interconnections with the input and output nodes modified in response to receipt of additional rating information to improve the usefulness of future ratings. Other artificial-intelligence techniques that may be used include the use of expert systems, the use of genetic algorithms, and the use of thermal-annealing techniques, all of which are familiar to those of skill in the art.

The results of the search are displayed at process block 824, permitting the user to select one or more of the items for purchase. In some instances, the user may find that none of the recommendations appears to be suitable and may wish to expand the scope of the search. One method by which the search may be expanded is to extend the search beyond the stored inventory of items. Thus, if a decision is made at decision block 828 to expand the search, products provided by the preferred merchants at their web sites may be searched at process block 832. This may be done by using a web robot implemented by the personal-shopping-assistant computer 120 (FIG. 1) that is configured to check the relevant web sites and to apply the selection criteria defined by the recipient's profile, as indicated at process block 832. A still more expansive search may be performed at process block 836 by performing a similar process with the web robot with additional merchants that are not identified by the profile as preferred by the recipient.

In cases where a search is performed by a web robot, the potential selections might not benefit from rating information provided by other users of the system, but it is still possible to apply known statistical techniques to rank the results according to how closely they relate to the profile information, particularly if the profile information includes preference scores as described above for some embodiments.

Once the results have been generated in this way, they are displayed to the user at process block 840, permitting the user to make a selection of one of the results at process block 844. The personal-shopping-assistant computer 120 (FIG. 1) may effect the actual transaction embodiments where the user has provided payment information associated with his account. In such instances, the user may be asked to confirm a desire to proceed with the transaction, with the personal-shopping-assistant computer 120 (FIG. 1) then supplying the payment and other information directly to the merchant and confirming all steps needed to complete the transaction (at process block 848). Such embodiments provide additional convenience to the user by simplifying the payment process, irrespective of who the supplying merchant is.

The user may additionally be given an opportunity to rank the success of the item as a gift at decision block 852, usually after the gift recipient has received the item. Such rankings may use a simple numerical scale to indicate how well received the item was. For instance, a ranking of 1 might mean that the gift was not well received; a ranking of 10 might indicate that the gift was extremely well received, and intermediate numerical values may give an indication of the success of the item in nonextreme cases. This information is used at process block 856 to update the stored rankings of items so that they may later be available to other users of the system in understanding how desirable the gift may be to other recipients having similar profile information.

It is generally expected that various aspects of the organizational structure used by the system in different embodiments will provide different levels of flexibility. For example, a very flexible system might allow a single recipient profile to be linked by multiple users, all of whom might be able to edit information in the profile to produce as accurate a representation of the relevant qualities of the recipient as possible. When those profiles include nonuniform prioritization indicators, the ability to match items against the profile is likely to be more successful. In addition, the use of rankings that indicate the success of individual items as gifts may be useful to other users in discriminating among what has the potential to be a large number of potential gift suggestions. Moreover, when the system allows a user to enter a profile, it becomes possible for the user to obtain personalized shopping recommendations for himself by identifying himself as the gift recipient. When used in combination with various filtering techniques, the system thus has the potential to aid users in finding particular types of products that the user is likely to be interested in.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method of establishing a shopping assistant utility, the method comprising:
receiving product information for a plurality of products from a vendor;
based on the received product information, automatically generating a product profile for each of the plurality of products, wherein each product profile includes a plurality of attributes assigned to each of the plurality of products;
receiving a search request including search criteria corresponding to at least one of the plurality of attributes;
comparing the search criteria with the plurality of attributes of the plurality of products to determine a level of correlation between each of the plurality of products and the search criteria;
generating a score assigned to each of the products based on the determined level of correlation; and
presenting the plurality of products in an ordered list based on the generated scores assigned to each of the products.

2. The method of claim 1, wherein the level of correlation is determined based at least in part on a sliding scale.

3. The method of claim 1, wherein product information is received in a first format.

4. The method of claim 3, further comprising:
translating the product information from the first format to an XML format; and
translating the product information from the XML format to a second format.

5. The method of claim 1, further comprising presenting a user with a user interface configured to receive the search criteria.

6. The method of claim 5, wherein the user interface is implemented using an iFrame.

7. The method of claim 1, wherein the plurality of attributes are each assigned a weight, wherein the assigned weight is factored into the determination of the level of correlation.

8. The method of claim 7, further comprising generating a weighted score based on the assigned weights to each of the attributes.

9. The method of claim 1, further comprising:
receiving a selection request for one of the plurality of products; and
searching the plurality of products to determine at least one complementary product associated with the selected product.

10. The method of claim 9, wherein the determination of at least one complementary product comprises:
comparing the one of the plurality of products with the plurality of products to determine a level of correlation between each of the plurality of products and the one of the plurality of products;
generating a score assigned to each of the products based on the determined level of correlation; and
presenting at least one of the plurality of products as the at least one complimentary product.

11. The method of claim 1, further comprising:
comparing the search request with a plurality of previous search requests, wherein each of the plurality of previous search requests includes lists of at least one of the plurality of products;
based on the comparing, determining a level of correlation between the search request and the plurality of previous search requests; and
presenting the lists associated with the plurality of previous search requests that have a level of correlation at least above a threshold.

12. The method of claim 1, further comprising presenting the assigned scores of each of the plurality of products.

13. The method of claim 1, wherein the assigned attributes comprise factual attributes, wherein a factual attribute is designated as true or false.

14. The method of claim 13, wherein the search criteria includes a false designation for at least one of the factual attributes.

15. The method of claim 14, further comprising based on the false designation, forgoing consideration of the false attribute from the determination of the level of correlation.

16. The method of claim 1, wherein the assigned attributes comprise negative attributes, wherein a negative attribute is an attribute that, if it is included in a product's profile, the product is excluded from being presented in response to the search.

17. The method of claim 1, further comprising presenting the plurality of products in the ordered list based on the generated scores assigned to each of the products being at least greater than a threshold.

18. The method of claim 1, wherein the vendor comprises a plurality of vendors, and wherein at least one of the plurality of vendors is a preferred vendor.

19. The method of claim 18, wherein products associated with a preferred vendor are assigned a higher score.

20. The method of claim 18, further comprising presenting products from the plurality of vendors in a centralized location, wherein the centralized location is configured to create a virtual mall.

21. The method of claim 1, further comprising:
flagging at least one of the plurality of products as a surplus product; and
assigning a flagged surplus product a higher score.

22. The method of claim 1, further comprising:
receiving a profile creation request from a customer; and
in response to the profile generation request, generating a profile for the customer.

23. The method of claim 22, further comprising:
generating at least one profile associated with the customer's profile; and
providing the customer with invitations to create a profile to send to potential customers.

24. The method of claim 23, further comprising sharing profile information amount customers.

25. The method of claim 23, wherein the vendor maintains supplemental information in addition to information included in the customer's profile.

26. The method of claim 22, further comprising transmitting reminders to the customer for at least one of an anniversary, a holiday, or a birthday event.

27. The method of claim 26, wherein the search request is based on the event for which the reminder has been transmitted.

28. The method of claim 1, wherein the shopping assistant utility is implemented on at least one of the following: a mobile device, a cellular device, a kiosk, and a personal computer.

29. A computer-readable storage medium having a computer-readable program embodied therein for establishing a shopping assistant utility including a communications system, a processor, and a storage device, wherein the computer-readable program includes:
instructions for receiving product information for a plurality of products;
instructions for based on the received product information, automatically generating a product profile for each of the plurality of products, wherein each product profile includes a plurality of attributes assigned to each of the products;
instructions for receiving a search request including search criteria corresponding to at least one of the plurality of attributes;
instructions for comparing the search criteria with the plurality of attributes of the plurality of products to determine a level of correlation between each of the plurality of products and the search criteria;
instructions for generating a score assigned to each of the products based on the determined level of correlation; and
instructions for presenting the plurality of products in an ordered list based on the generated scores assigned to each of the products.
